(19) United States
(12) Patent Application Publication
(10) Pub. No.: US 2026/0210127 A1
(43) Pub. Date: Jul. 23, 2026

(54) Decorative Member and Method for Manufacturing Decorative Member

(71) Applicant: Yamaha Fine Technologies Co., Ltd., Hamamatsu-sh (JP)

(72) Inventors: Shuto SUZUKI, Hamamatsu-shi (JP); Yutaka HAMADA, Shizuoka-shi (JP); Hayato SOBUE, Kakegawa-shi (JP)

(21) Appl. No.: 19/451,488

(22) Filed: Jan. 16, 2026

(30) Foreign Application Priority Data
Jan. 20, 2025 (JP) 2025-007710

(51) Int. Cl. E04F 13/08; B27D 5/00; B44C 5/04

(52) U.S. Cl. CPC E04F 13/0866; B27D 5/00; B44C 5/04

(57) ABSTRACT

A decorative member that exhibits an excellent appearance with a simple configuration is disclosed. According to various aspects, a decorative member includes a veneer, a backing material disposed on a first surface of the veneer, and a film disposed on a second surface of the veneer.

### TECHNICAL FIELD

The present disclosure relates to a decorative member and a method for manufacturing the decorative member.

### BACKGROUND

Decorative members with wood grain patterns are widely used. Patent Document 1 discloses a decorative member in which filler thermoplastic films are welded to both sides of a veneer, and stretchable films are heat-pressed onto surfaces of the respective filler thermoplastic films.

Patent Document 1: JP 2005-313345 A

Patent Document 1 discloses a method in which the filler thermoplastic film is impregnated into vessels and woody parts of the veneer, and then the surface of the filler thermoplastic film is protected by a stretchable film. Patent Document 1 discloses that it is possible to form even complex three-dimensional curved surfaces by providing the filler thermoplastic film with a function of a reinforcing material for relieving stress concentration of the veneer and a function of an adhesive for adhering the veneer with the stretchable film,

The disclosure in Patent Document 1 has a problem in terms of providing a decorative member that exhibits excellent appearance with a simpler configuration.

### SUMMARY

An object of one aspect of the present disclosure is to provide a decorative member that exhibits an excellent aesthetic appearance with a simple configuration.

(1) A decorative member according to one aspect of the present disclosure consists of a veneer, a backing material disposed on a first surface of the veneer and a film disposed on a second surface of the veneer.

(2) In the above item (1), it is preferable that the backing material is breathable.

(3) In the above item (1) or (2), it is preferable that the film is made of a thermoplastic resin, and an average thickness of the film is preferably 150 μm or less.

(4) In any one of the above items (1) to (3), it is preferable that the veneer is colored or bleached.

(5) In the above item (4), the second surface is preferable to be an open-pore finished surface.

(6) According to another aspect of the present disclosure, a method for manufacturing the decorative member consisting of the veneer, the backing material disposed on the first surface of the veneer, and the film disposed on the second surface of the veneer, includes steps of laminating the backing material onto the first surface and of laminating the film to the second surface.

The decorative member according to one aspect of the present disclosure exhibits an excellent aesthetic appearance with a simple configuration.

### BRIEF DESCRIPTION OF DRAWINGS

FIG. 1 is a schematic cross-sectional view illustrating a decorative member according to one embodiment of the present disclosure;

FIG. 2 is a schematic diagram illustrating a first laminating step in a method for manufacturing the decorative member according to one embodiment of the present disclosure; and

FIG. 3 is a schematic diagram illustrating a second laminating step in the method for manufacturing the decorative member according to one embodiment of the present disclosure.

### DETAILED DESCRIPTION

The embodiments of the present disclosure will now be described in detail with reference to the drawings as appropriate. It should be noted that with respect to numerical values disclosed in the present specification, it is possible to adopt only either the upper limit value or the lower limit value, or to arbitrarily combine the upper limit value and the lower limit value. All combinable numerical ranges are disclosed herein as preferable ranges. In addition, each drawing is schematic, and may not correspond to the actual dimensions, ratios, and the like. In the present disclosure, the terms “first” and “second” are used merely to distinguish the respective components to which they are attached, and do not limit the number, order, priority, or the like thereof.

### Decorative Member

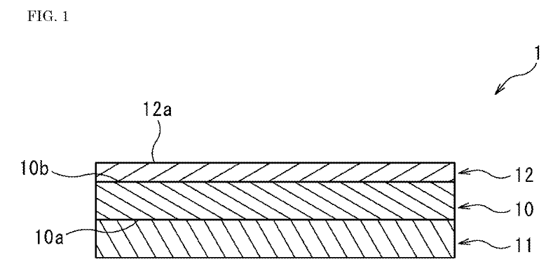

As shown in FIG. 1, a decorative member 1 according to one embodiment of the present disclosure is composed of a veneer 10, a backing material 11 disposed on a first surface 10a of the veneer 10, and a film 12 disposed on a second surface 10b of the veneer 10. The decorative member 1 is a three-layer structure consisting of the veneer 10, the backing material 11, and the film 12.

The decorative member 1 is generally used in a state in which the film 12 is positioned on a viewer side. Since the decorative member 1 has a three-layer structure including the veneer 10, the backing material 11, and the film 12, its configuration is simple. In addition, because the film 12 is merely disposed on the second surface 10b of the veneer 10, an appearance of the veneer 10 can be easily emphasized. Accordingly, the decorative member 1 exhibits an excellent appearance with the simple configuration.

### Veneer

The veneer 10 is a sheet-like wood obtained by slicing solid wood into a thin sheet. The type of the wood can be selected according to the intended use or other factors. As described later, the decorative member 1 may be used, for example, as an interior member for an automobile. In this case, the wood may be, for example, walnut, maple, ash, tamo, birch, beech, sapele, poplar, eucalyptus, agathis, linden, basswood, cedar, bamboo, and cork. As also described later, the decorative member 1 may be used as a musical instrument component. In this case, the wood may be, for example, rosewood, maple, ebony, Ezo spruce, spruce, and granadilla.

The veneer 10 may be uncolored and unbleached, but may also be colored or bleached. By being colored or bleached, the veneer 10 can have its appearance more easily enhanced.

In a case where the veneer 10 is uncolored and unbleached, recesses of vessels are present on the second surface 10b. In a case where the veneer 10 is colored or bleached, it is preferable that the second surface 10b is an open-pore finished surface. The term "open-pore finish" refers to a finish in which the pores of the vessels are not filled. Accordingly, when the second surface 10b is an open-pore finished surface, recesses of the vessel are present on the second surface 10b. Because the decorative member 1 has recesses of the vessels on the second surface 10b, the texture of the wood can be readily emphasized. In particular, when the veneer 10 is colored or bleached and the second surface 10b is an open-pore finished surface, the decorative member 1 can emphasize the aesthetic appearance derived from the wood while exhibiting a color tone according to the intended application or the viewer’s preference.

As for the method for coloring the veneer 10, it is not particularly limited, and it is also possible to color it by painting with a pigment. On the other hand, as the coloring method, it may be preferable to perform coloring using a dye. For example, it is also preferable to substitute hydrogen atoms contained in hydroxyl groups in the wood with acetyl groups, and then dye this wood with a disperse dye in supercritical carbon dioxide. According to this embodiment, the disperse dye can be made to penetrate into gaps between fibers of the wood. Therefore, the wood can be uniformly colored while sufficiently leaving minute irregularities such as concave portions of vessels on the second surface 10b.

The method for bleaching the veneer 10 is not particularly limited, and examples thereof include a method in which the wood is immersed in or coated with a bleaching solution.

An average thickness of the veneer 10 can be set in accordance to its application. On the other hand, since the decorative member 1 is formed of three-layers of the veneer 10, the backing material 11, and the film 12, its thickness can be readily reduced. Because the thickness of the decorative member 1 is small, its flexibility can be readily improved. From this standpoint, an upper limit of the average thickness of the veneer 10 may be 1.0 mm, and may also be 0.5 mm. A lower limit of the average thickness of the veneer 10 may be 0.1 mm, and may also be 0.2 mm from a standpoint of increasing strength.

### Backing Material

The backing material 11 reinforces the veneer 10 from its back side, i.e., the side opposite to the visible side. It is preferable that the backing material 11 is flexible. Because the decorative member 1 has the flexible backing material 11, it can be easily deformed into a desired shape while improving its handling properties. Moreover, according to this embodiment, when the veneer 10 and the backing material 11 are laminated together, the first surface 10a of the veneer 10 is pressed by the soft material. As a result, cracking of the veneer 10 and damage to the vessels and the like can be more easily suppressed.

In addition, it is preferable that the backing material 11 has breathability. That is, it is preferable that the backing material 11 has a plurality of air passages that communicate in the thickness direction. According to this embodiment, when the veneer 10 and the film 12 are laminated together in a state in which the backing material 11 is disposed on the first surface 10a of the veneer 10, it is possible to prevent air bubbles from being generated between the veneer 10 and the film 12. As a result, the veneer 10 and the film 12 can be easily and reliably brought into contact with each other, improving the aesthetic appearance and making it easier to make the shape of the surface 12a of the film 12 follow the shape of the second surface 10b of the veneer 10. Still more, if the backing material 11 has breathability, the bleaching solution used in bleaching the veneer 10 can be readily discharged through the air passages. Therefore, it is possible to improve manufacturing efficiency of the decorative member 1. For instance, a drying process after bleaching the veneer 10 can be omitted.

The backing material 11 may be made of fabric, for example. Because fabric hardly emits greenhouse gases during its production, it is possible to contribute in improving sustainability. Examples of the fabric include woven fabrics, knitted fabrics, and nonwoven fabrics. Above all, the fabric may be a cotton fabric.

The backing material 11 and the veneer 10 are adhered together by, for example, an adhesive. The adhesive may be a sheet member, i.e., an adhesive sheet.

### Film

The film 12 is transparent, and may be, for example, colorless and transparent. In addition, the film 12 is flexible.

A main component of the film 12 is a synthetic resin. In particular, the film 12 is preferably made of a thermoplastic resin. According to this embodiment, the thermoplastic resin can be melt-pressed onto the second surface 10b of the veneer 10. As a result, the film 12 and the veneer 10 can be directly laminated, and the film 12 and the veneer 10 can be brought into direct contact with each other without using an adhesive for example. Because the film 12 and the veneer 10 are in close direct contact with each other, the shape of the surface 12a of the film 12, (the surface opposite to the side facing the veneer 10, i.e., the outermost surface of the decorative member 1) can easily follow the shape of the second surface 10b of the veneer 10. Note that the term "main component" refers to a component having the largest content on a mass basis, for example, a component with a content of 50 mass% or more.

Examples of the thermoplastic resin include vinyl resins such as polyvinyl chloride and polyvinyl acetate, acrylic resins, polyolefins, polystyrene, acrylonitrile-butadiene-styrene copolymers (ABS resins), polyesters, polycarbonates, cellulose resins, polyamides, thermoplastic polyurethanes, and fluororesins. Above all, acrylic resin is preferred.

The film 12 may also be adhered to the second surface 10b of the veneer 10 using an adhesive. In this case, the film 12 may be made of a thermoplastic resin or a thermosetting resin. When the film 12 is made of a thermoplastic resin, examples of the thermoplastic resin include the same as those described above. On the other hand, when the film 12 is made of a thermosetting resin, examples of the thermosetting resin include epoxy resin and thermosetting polyurethane.

A thickness of the film 12 is uniform. An upper limit of an average thickness of the film 12 is preferably 150 μm, more preferably 100 μm, and even more preferably 80 μm, from the aspect of making it easier to conform the shape of the surface 12a of the film 12 to the shape of the second surface 10b of the veneer 10. On the other hand, a lower limit of the average thickness is preferably 10 μm, more preferably 30 μm, from the aspect of protecting the second surface 10b of the veneer 10.

The shape of the surface 12a of the film 12 can be easily and reliably made to follow the shape of the second surface 10b of the veneer 10 by making the film 12 by the thermoplastic resin and by making the average thickness thereof equal to or less than the upper limit in the decorative member 1.

The upper limit of the average thickness of the entire decorative member 1 may be 1.1 mm, 0.6 mm, or 0.4 mm from the aspect of enhancing flexibility. The decorative member 1 is a three-layer structure consisting of the veneer 10, the backing material 11, and the film 12, and therefore it is easy to reduce the average thickness and to increase flexibility. On the other hand, the lower limit of the average thickness of the entire decorative member 1 can be, for example, 0.3 mm from the aspect of improving strength and handling properties.

The decorative member 1 may have a through-hole (not shown) penetrating in the thickness direction. The use of the through-hole is not particularly limited, but may be, for example, a light-transmitting hole. In the decorative member 1, a wavelength band in which an absorption rate of laser light is optimized is approximately the same in each of the layers, i.e., the veneer 10, the backing material 11, and the film 12. Therefore, the desired through holes can be formed easily and reliably.

The decorative member 1 may be an interior member for an automobile. The decorative member 1 has a simple configuration and exhibits an excellent appearance. Moreover, the decorative member 1 can be made extremely thin and highly flexible. Therefore, the decorative member 1 is suitable as an interior member for an automobile.

The decorative member 1 may also be a musical instrument member. The decorative member 1 has a simple configuration and exhibits an excellent appearance. Moreover, the decorative member 1 can be made extremely thin and highly flexible. Therefore, the decorative member 1 can be suitably used as a musical instrument member. While the musical instrument members are not specifically limited, examples thereof include keys in keyboard instruments, fingerboards in string instruments such as guitars and violins, and tone plates in tone plate percussion instruments such as marimbas.

### Manufacturing method of decorative member

Next, a method for manufacturing the decorative member according to one embodiment of the present disclosure (simply referred also as "the manufacturing method" hereinafter) will be described. This manufacturing method can be used as a method for manufacturing the decorative member 1 shown in FIG. 1.

The manufacturing method is a method for manufacturing the decorative member 1 that is composed of the veneer 10, the backing material 11 disposed on the first surface 10a of the veneer 10, and the film 12 disposed on the second surface 10b of the veneer 10. In this manufacturing method, the backing material 11 is laminated to the first surface 10a (first laminating step S1), and the film 12 is laminated to the second surface 10b (second laminating step S2).

This manufacturing method allows to easily manufacture the decorative member 1 that has a simple configuration and exhibits an excellent appearance.

### First laminating step

As described above, the backing material 11 is laminated to the first surface 10a of the veneer 10 in the first laminating step S1. The veneer 10 used in the first laminating step S1 may be the same as the veneer 10 described in the decorative member 1. The backing material 11 used in the first laminating step S1 may be the same as the backing material 11 described for the decorative member 1.

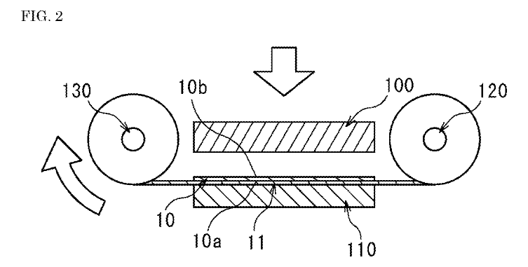

An example of the laminating procedure in the first laminating step S1 will be described with reference to FIG. 2. As shown in FIG. 2, in the first laminating step S1, the backing material 11 is laminated to the first surface 10a of the veneer 10 along a conveying path from a first roll 120 to a second roll 130 while feeding the backing material 11 wound around the first roll 120 to the second roll 130. In the first laminating step S1, for example, the upper surface of the backing material 11, i.e., the surface facing upward in the conveying path, and the first surface 10a of the veneer 10 are laminated together. The veneer 10 and the backing material 11 may be laminated together using, for example, an adhesive. In the first laminating step S1, the two-layer structure in which the veneer 10 and the backing material 11 are laminated together may be wound up as it is onto the second roll 130. Since the two-layer structure is highly flexible, it can be easily wound onto the second roll 130.

In the first laminating step S1, the lower surface of the backing material 11, i.e., the surface opposite to the surface to be laminated with the veneer 10 is supported by a support table 110, and the veneer 10 is pressed onto the upper surface of the backing material 11. At this time, in the first laminating step S1, the veneer 10 may be pressed by an elastic member 100. This embodiment enables to easily suppress damage otherwise caused to the vessels of the veneer 10. That is, it is possible to easily suppress damage otherwise caused to the vessels because the veneer 10 is pressed from both sides by the backing material 11 and the elastic member 100, both of which are flexible, and the vessels are prevented from being pressed directly by the rigid member,. As a result, the veneer 10 and the backing material 11 can be laminated together while maintaining the original texture of the wood.

### Second laminating step

As described above, in the second laminating step S2, the film 12 is laminated to the second surface 10b of the veneer 10. The film 12 used in the second laminating step S2 can be the same as the film 12 described in the decorative member 1.

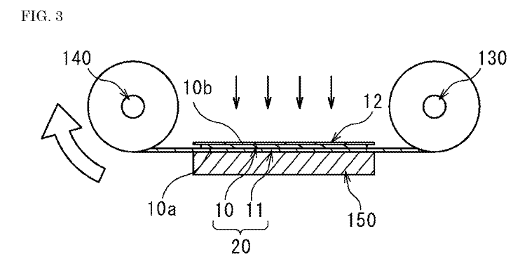

An example of the laminating procedure in the second laminating step S2 will be described with reference to FIG. 3. As shown in FIG. 3, in the second laminating step S2, the two-layer structure 20 of the veneer 10 and the backing material 11 wound around the second roll 130 is fed to a third roll 140, and the film 12 is laminated to the second surface 10b of the veneer 10 along a conveying path from the second roll 130 to the third roll 140. The film 12 may be melt-pressed onto the veneer 10 or may be laminated to the veneer 10 using an adhesive. In the second laminating step S2, the three-layer structure in which the film 12 is laminated to the two-layer structure 20 of the veneer 10 and the backing material 11 may be wound up as it is onto the third roll 140. The three-layer structure is highly flexible, so that it be easily wound onto the third roll 140.

In the second laminating step S2, the film 12 is pressed onto the second surface 10b of the veneer 10 while supporting the lower surface of the backing material 11 by a support table 150. According to this embodiment, the shape of the surface 12a of the film 12 can be easily made to follow the shape of the second surface 10b of the veneer 10 while suppressing damages to the vessels of the veneer 10. As a result, the viewer can easily perceive the texture of the veneer 10.

### Other embodiments

The foregoing embodiments do not limit the configuration of the present disclosure. Accordingly, the foregoing embodiments allow omission, substitution, or addition of constituent elements of each part of the embodiment based on the description of the present specification and common technical knowledge, and all such modifications should be construed as falling within the scope of the present disclosure.

In the embodiments described above, fabric is illustrated as the backing material. However, in this disclosure, the backing material is not limited to fabric. Depending on the application, the decorative member may not be required to have high flexibility. In such a case, a rigid member can be used as the backing material. The backing material may also be configured to be non-breathable.

In the foregoing embodiment, the configuration in which the second surface of the veneer is an open-pore finished surface has been described. However, depending on the application, there may be a case in which the second surface is desired to be a mirror finish. In such a case, the second surface needs not to be an open-pore surface.

The foregoing embodiment has been described as performing the first and second laminating steps S1 and S2 in this order. However, the present disclosure does not intend to exclude a procedure of performing the second laminating step S2 before the first laminating step S1 or of performing the first and second laminating steps S1 S2 simultaneously.

As described above, the decorative member is a three-layer structure consisting of the veneer, the backing material and the film. However, as for the decorative member, it is possible to dispose another layer on the surface of the film or to dispose another layer on the back of the backing material depending on the specific use situation.

What is claimed is:

1. A decorative member comprising:
a veneer;
a backing material disposed on a first surface of the veneer; and
a film disposed on a second surface of the veneer.

2. The decorative member according to claim 1,
wherein the backing material is breathable.

3. The decorative member according to claim 1,
wherein the film is made of a thermoplastic resin, and
wherein an average thickness of the film is 150 μm or less.

4. The decorative member according to claim 1,
wherein the veneer is colored or bleached.

5. The decorative member according to claim 4,
wherein the second surface is an open-pore finished surface.

6. A method for manufacturing a decorative member comprising a veneer, a backing material disposed on a first surface of the veneer, and a film disposed on a second surface of the veneer, the method comprising:
laminating the backing material to the first surface; and
laminating the film to the second surface.

7. The method according to claim 6,
wherein the backing material is breathable.

8. The method according to claim 6,
wherein the film is made of a thermoplastic resin, and
wherein an average thickness of the film is 150 μm or less.

9. The method according to claim 6,
wherein the veneer is colored or bleached.

10. The method according to claim 9,
wherein the second surface is an open-pore finished surface.
